(19) United States
(12) Patent Application Publication
(10) Pub. No.: US 2012/0301729 A1
(43) Pub. Date: Nov. 29, 2012

(54) TWO-COMPONENT ADHESIVE OR SEALANT COMPOSITION COMPRISING ACCELERATOR COMPONENT

(75) Inventors: Martin Schmider, Hamburg (DE); Urs Jaeger, Jona (CH); Andreas Kramer, Zurich (CH)

(73) Assignee: SIKA TECHNOLOGY AG, Baar (CH)

(21) Appl. No.: 13/508,438

(22) PCT Filed: Oct. 22, 2010
(86) PCT No.: PCT/EP2010/065999

§ 371 Date: Jun. 22, 2012

(30) Foreign Application Priority Data
Nov. 6, 2009 (EP) 09175201.4

(51) Int. Cl. C09J 175/04; C09D 175/04; B32B 43/00; B32B 7/12; B32B 37/12

(52) U.S. Cl. 428/423.1; 156/305; 427/140; 524/590

(57) ABSTRACT

The present invention relates to a two-component adhesive or sealant composition which consists of a first component K1 and an accelorator component K2. The first component K1 here comprises at least one polyurethane polymer having isocyanatic groups, and the accelorator component K2 comprises at least one salt of a tertiary amine and/or an organic quaternary ammonium salt. These compositions have optional caring characteristics for relatively large adhesive bonds, and more particularly have a sufficiently long open time combined with a rapid strength buildup.

### TECHNICAL FIELD

The invention relates to the field of polyurethane adhesives and polyurethane sealants, in particular for the field of industrial bonding.

### STATE OF THE ART

Polyurethane adhesives and sealants have long been known and are used routinely in industrial processes. Single-component polyurethane adhesives and sealants cure in the presence of moisture. However curing, as a result of diffusion processes, occurs very slowly and fastening means are required in order to secure the parts to be bonded. Thus, a big problem with one-component polyurethane adhesives and polyurethane sealants is that they are very slow to cure.

Frequently, two-component (meth)acrylate adhesives are employed as rapid adhesive systems, but these are disadvantageous as compared to polyurethane adhesives because they contain dangerous peroxides, and additionally interfering stickiness develops on the surface of said adhesives when exposed to air or oxygen.

On the other hand, two-component polyurethane adhesives are known in which the second component represents a hardener and which contains substances that react in an addition reaction with the isocyanates present in the first component, resulting in cross-linking. However, this curing occurs very rapidly, almost immediately, after the two components are mixed. In practice, this type of adhesives is best suited, therefore, only for point gluing or for bonding together small parts. When bonding together larger parts, such as, for example, automobile windshields, a curing rate of this type is too rapid, since the open time is exceeded even before contact with the second substrate, in particular before final positioning of the latter, and for this reason certain bondings can be achieved only with extreme demands being placed on the adhesive application or joining process, or not at all. It is understood that in the case of these two-component adhesives and sealants, the error tolerance is extremely small. A further disadvantage of the two-component polyurethane adhesives based on the curing mechanism of an addition reaction are the exacting requirements that must be imposed on the quality of mixing, since even small mixing errors can lead to a sharp drop in mechanical values.

In order to enhance the slow curing of one-component polyurethane adhesives and polyurethane sealants, it is possible to a certain degree to add accelerators such as tertiary amines or organotin compounds The disadvantage of such accelerators, however, is that the acceleration that occurs is minimal or the storage stability is significantly reduced.

The addition of water to a one-component polyurethane adhesive or polyurethane sealant in the form of a second component is another form of acceleration. In this case, acceleration is very strong, but along with the aforementioned disadvantages of the two-components composition, other problems occur, namely, the formation of bubbles and at best, in particular when using a static mixer, the formation of layers of insufficiently cured material.

In another approach to solving this problem, it was proposed in WO 2007/135187 A1 to admix zinc, lead or iron(III) complexes with a one-component polyurethane adhesive or polyurethane sealant. It was found that curing can be accelerated with this system, but not to the degree required for rapid industrial processes, namely to such a degree that within just 15 minutes a level of cross-linking is intended to be achieved that already allows stress to be applied to the composite.

### DESCRIPTION OF THE INVENTION

The object of the present invention is therefore to provide a polyurethane-based sealant or adhesive which exhibits a curing characteristic that, on the one hand, includes a sufficiently long open time to enable the bonding of large-surface-area substrates and, on the other hand, that is rapid enough so that after just 15 minutes, a level is achieved that already allows stress to be applied to the composite.

Surprisingly, it was found that a two-component adhesive or sealant composition as claimed in claim 1 solves this problem. In particular, compositions of this type also overcome the disadvantages of the prior art. It was found that this type of adhesive or sealant exhibits mechanical final strengths that are substantially identical to the corresponding one-component adhesive or sealants made solely of the first component K1, that is, without the addition of the accelerator component K2, and cured solely in the presence of atmospheric moisture over a long period of time. In addition, it has been found that the cured two-component adhesives or sealants are advantageously substantially free of bubbles or layers of insufficient mechanics, in sharp contrast to the prior art adhesives, in which a water component is added, in particular by means of a static mixer.

The compositions, based on the curing characteristic thereof, are particularly suited as adhesives or sealants, above all for industrial applications.

Further aspects of the invention are the subject matter of other independent claims. Especially preferred embodiments of the invention are the subject matter of the dependent claims.

### MODES FOR CARRYING OUT THE INVENTION

A first subject matter of the present invention is a two-component adhesive or sealant compound comprising a first component K1 and an accelerator component K2.

The first component K1 contains at least one polyurethane polymer having isocyanate groups, and the accelerator component K2 contains at least one salt of a tertiary amine and/or a quaternary ammonium salt.

The term “primary amino group” in the present document denotes an amino group in the form of an NH₂ group which is bound to an organic residue. The term “secondary amino group” denotes an amino group in which the nitrogen atom is bound to two organic residues, which together can also be part of a ring. The term “tertiary amino group” denotes an amino group in which the nitrogen atom (=tertiary amine-nitrogen) is bound to three organic residues, wherein two of these residues together can also be part of a ring.

The term “quaternary ammonium group” denotes an amino group in which four organic residues are bounded to a positively charged nitrogen atom. Accordingly, a compound that includes a quaternary ammonium group is referred to as a “quaternary ammonium compound” and a “quaternary ammonium salt” is understood to be a salt-like compound of a quaternary ammonium compound and a least one anion.

“Room temperature” in the present document is understood to indicate a temperature of 25° C.

The prefix “poly” in substance names such as polyamine, polyol, or polyisocyanate in the present document denotes substances which, per molecule, contain formally two or more of the functional groups that occur in the name.

The term “polymer” encompasses in the present document on the one hand an aggregate of macromolecules which are chemically defined but, relative to the degree of polymerization, molecular weight and chain length, differ from each other, which was prepared by a polyreaction (polymerization, polyaddition, polycondensation). On the other hand, the term also encompasses derivatives of such an aggregrate of macromolecules from polyreactions, that is to say, compounds obtained by reaction, such as, for example, additions or substitutions, of functional groups on predefined macromolecules, and which can be chemically defined or chemically undefined. Further, the term also encompasses so-called pre-polymers, that is, reactive oligomeric pre-adducts, the functional groups of which participate in the building of the macromolecules.

The term “polyurethane polymer” encompasses all polymers that are prepared according to the so-called diisocyanate-polyaddition method. This also includes polymers that are substantially or completely free of urethane groups. Examples of polyurethane polymers include polyether-polyurethanes, polyester-polyurethanes, polyether-polyurea, polyurea, polyester-polyurea, polyisocyanurates and polycarbodiimides.

The bolded designations such as K1, K2 S1, S2 or the like in the present document are merely for purposes of better reading comprehension and identification.

“Substantially free” in the present document is understood to mean a quantity which contains only minimal parts, typically less that 1% by weight, and more particularly less than 0.1% by weight, of the relevant substance.

The first component K1 comprises a polyurethane polymer containing at least one isocyanate group.

The polyurethane polymer containing the isocyanate group can be obtained in particular from reacting at least one polyol with at least one polyisocyanate. This reaction can be achieved by reacting the polyol and the polyisocyanate using conventional methods, for example, at temperatures of 50° C. to 100° C., where appropriate with accompanying use of suitable catalysts, the polyisocyanate being metered such that the isocyanate groups thereof are in stoichiometric excess in relation to the hydroxyl groups of the polyol. The polyisocyanate is advantageously metered such that an NCO/OH ratio of 1.3 to 5, and more particularly a ratio of 1.5 to 3, is maintained. “NCO/OH-ratio” is understood to mean the ratio of the number of isocyanate groups used to the number of hydroxyl groups used. Preferably, after all hydroxyl groups of the polyol have been reacted, a content of 0.5% to 15% by weight, and more preferably of 0.5 to 5% by weight, of free isocyanate groups remains in the polyurethane polymer.

Where appropriate, the polyurethane polymer can be prepared using plasticizers, in which case the plasticizers used contain no isocyanate-reactive groups.

Polyols which can be used for preparing the polyurethane polymer include, for example, the following commercially available polyols or mixtures thereof:
polyoxyalkylene polyols, also called polyether polyols or oligoetherols, which are polymerization products of ethylene oxide, 1,2-propylene oxide, 1,2- or 2,3-butylene oxide, oxetane, tetrahydrofuran or mixtures thereof, optionally polymerized by means of a starter molecule having two or more active hydrogen atoms, such as, for example, water, ammonia or compounds having several OH or NH groups, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline and mixtures of the aforementioned compounds. Use can also be made not only of polyoxylalkylene polyols, which have a low degree of unsaturation (measured according to ASTM D-2849-69 and reported in milliequivalents of unsaturation per gram of polyol (mEq/g)), prepared, for example, with the aid of what are called double metal cyanide complex catalysts (DMC catalysts), but also polyoxyalkylene polyols having a higher degree of unsaturation, prepared, for example, with the aid of anionic catalysts such as NaOH, KOH, CsOH or alkali alcoholates.
   Particularly suitable are polyoxyalkylene diols or polyoxyalkylene triols, and more particularly polyoxyethylene- and polyoxypropylene diols and trials.
   Especially suitable are polyoxyalkylene diols and triols having a degree of unsaturation of less than 0.02 meq/q and having a molecular weight in the range of 1,000 to 30,000 g/mol, and polyoxypropylene diols and triols having a molecular weight of 400 to 8,000 g/mol.
   Likewise, particular suitable are what are called ethylene oxide-terminated (“EO-endcapped”, ethylene oxide-endcapped) polyoxypropylene polyols.
   The latter are special polyoxypropylene-polyoxyethylene polyols which are obtained, for example, by subjecting pure polyoxypropylene polyols, and more particularly polyoxypropylene dials and trials, after completion of the polypropoxylation reaction, to continued alkoxylation with ethylene oxide, and which as a result contain primary hydroxyl groups.
Styrene-acrylonitrile- or -acrylonitrile-methyl methacrylate-grafted polyether polyols
Polyester polyols, also called oligoesterols, prepared in accordance with known methods, in particular polycondensation of hydroxycarboxylic acids or the polycondensation of aliphatic and/or aromatic polycarboxylic acids having divalent or multivalent alcohols.

Particularly suitable polyester polyols are those that are prepared from divalent to trivalent, in particular divalent alcohols, such as, for example, ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexane dimethanol, dimeric fatty acid diols (dimer diol), hydroxypivalic acid neopentylglycol ester, glycerol, 1,1,1-trimethylolpropane or mixtures of the aforementioned alcohols, with organic di- or tri-carboxylic acids, in particular, dicarboxylic acids, or the anhydrides or esters thereof, such as, for example, succinic acid, glutaric acid, adipic acid, trimethyladipic acid, suberic acid, azelaic acid, sebacic acid, dodecanedicarboxylic acid, maleic acid, fumaric acid, dimeric fatty acid, phthalic acid, phthalic acid anhydride, isophthalic acid, terephthalic acid, dimethyltherephthalate, hexahydrophthalic acid, trimellitic acid and trimellitic acid anhydride, or mixtures of the aforementioned acids, as well as polyester polyols formed from lactones such as ε-caprolactone and starters such as the aforementioned divalent or trivalent alcohols.

Particularly suitable polyester polyols are polyester diols.
Polycarbonate polyols, as accessed be reacting, for example, the above-mentioned alcohols—used to build the polyester polyols—having dialkyl carbonates, diaryl carbonates or phosgenes.
Block copolymers which carry at least two hydroxyl groups and which include at least two different blocks having a polyether, polyester and/or polycarbonate structure of the kind described above, in particular polyetherpolyester polyols.
Polyacrylate and polymethacrylate polyols.
Polyhydroxy-functional fats and oils, for example, natural fats and oils, in particular castor oil; so-called oleochemical polyols, obtained through chemical modification of natural fats and oils, for example, epoxypolyester or epoxypolyether obtained by epoxidation of unsaturated oils and subsequent ring opening with carboxylic acids or alcohols, or polyols obtained through hydroformylation and hydrogenation of unsaturated oils; or polyols obtained from natural fats and oils through degradation processes such as alcoholysis or ozonolysis and subsequent chemical linking, for example, by transesterification or dimerization of the thus obtained degradation products or derivatives. Suitable degradation products of natural fats and oils include, in particular, fatty acids and fatty alcohols such as fatty acid esters, in particular, the methyl esters (FAME), which can be derivatized, for example, by way of hydroformylation and hydrogenation to form hydroxy fatty acid esters.
Polyhydrocarbon polyols, also called oligohydrocarbonols, such as, for example, polyhydroxy-functional polyolefins, polyisobutylenes, polyisoprenes; polyhydroxy-functional ethylene-propylene, ethylene-butylene or ethylene-propylene-diene copolymers of the kind manufactured, for example, by the company Kraton Polymers; polyhydroxy-functional polymers of dienes, in particular 1,3-butadiene, which in particular can be prepared from anionic polymerization; polyhydroxy-functional copolymers from dienes, such as 1,3-butadiene or diene mixtures and vinyl monomers such as styrene, acrylonitrile, vinyl chloride, vinyl acetate, vinyl alcohol, isobutylene and isoprene, for example polyhydroxy-functional acrylonitrile/butadiene-copolymers of the kind, for example, that can be prepared from epoxies or amino alcohols and carboxyl-terminated acrylonitrile/butadiene-copolymers (commercially available, for example, under the name Hypro® (previously Hycar®) CTBN and CTBNX and ETBN from the company Nanoresins AG, or Emerald Performance Materials LLC); as well as hydrogenated polyhydroxy-functional polymers or copolymers of dienes.

These named polyols preferably have an average molecular weight of 250 to 30,000 g/mol, and more particularly of 400 to 20,000 g/mol, and preferably an average OH functionality in the range of 1.6 to 3.

Preferred polyols include polyether, polyester, polycarbonate and polyacrylate polyols, preferably diols and triols.

Especially preferred are polyether polyols, and more particularly polyoxypropylene and polyoxypropoylene polyoxyethylene polyols, as well as liquid polyester polyols and polyetherpolyester polyols.

Especially preferred are, in addition, amorphous, semi-crystalline and crystalline polyester and polycarbonate diols having a melting point in the range of 40° C. to 80° C., and more particularly 50° C. to 70° C., in particular adipic acid/hexanediol-polyester, azelaic acid/hexanediol-polyester, dodecane dicarboxylic acid/hexanediol-polyester and hexane diol-based polycarbonate dials.

In addition to these named polyols, it is possible to use small amounts of low-molecular-weight divalent or multivalent alcohols, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher order alcohols, low-molecular-weight alkoxylation products of the aforementioned divalent and multivalent alcohols, and also mixtures of the aforementioned alcohols, in the preparation of the polyurethane polymer. It is also possible to use, in addition, small amounts of polyols having an average OH-functionality of greater than 3, for example sugar polyols.

Aromatic or aliphatic polyisocyanates, in particular diisocyanates, are used as the polyisocyanate for preparing the polyurethane polymer containing isocyanate groups

Particularly suitable aromatic polyisocyanates include, in particular, monomeric di- or triisocyanates such as 2,4- and 2,6-toluene diisocyanate and any desired mixtures of these isomers (TDI), 4,4′-, 2,4′- and 2,2′-diphenylmethane diisocyanate and any desired mixtures of these isomers (MDI), mixtures of MDI and MDI homologues (polymeric MDI or PMDI), 1,3- and 1,4-phenylene diisocyanate, 2,3,5,6-tetramethyl-1,4-diisocyanatobenzene, naphthalene-1,5-diisocyante (NDI), 3,3′-dimethyl-4,4-diisocyanatodiphenyl (TODI), dianisidine diisocyanate (DADI), 1,3,5-tris-(isocyanatomethyl)-benzene, tris-(4-isocyanatophenyl)-methane, tris-(4-isocyanatophenyl)-thiophosphate, oligomers and polymers of the aforementioned isocyanates, and any desired mixtures of the aforementioned isocyanates. Preference is given to MDI and TDI.

Particularly suitable aliphatic polyisocyanates include, in particular, monomeric di- or triisocyanates such as 1,4-tetramethylene diisocyanate, 2-methylpentamethylene-1,5-diisocyanate, 1,6-hexamethylene diisocyanate (HDI), 2,2,4- and 2,4,4-trimethyl-1,6-hexamethylene diisocyanate (TMDI), 1,10-decamethylene diisocyanate, 1,12-dodecamethylene diisocyanate, lysine and lysine ester diisocyanate, cyclohexane-1,3- and -1,4 diisocyanate, 1-methyl-2,4- and -2,6-diisocyanato cyclohexane and any desired mixtures of these isomers (HTDI or H₆TDI), 1-isocyanato-3,3,5-trimethyl-5-isocyanatomethyl-cyclohexane (=isophorone diisocyanate or IPDI), perhydro-2,4′- and -4,4′-diphenylmethane diisocyanate (HMDI) or H₁₂MDI), 1,4-diisocyanato-2,2,6-trimethylcyclohexane (TMCDI), 1,3- and 1,4-bis-(isocyanatomethyl)-cyclohexane, m- and p-xylylene diisocyanate (m- and p-XDI), m- and p-tetramethyl-1,3- and -1,4-xylylene diisocyanate (m- and p-TMXDI), bis-(1-isocynato-1-methylethyl)-naphthalene, dimer and trimer fatty acid isocyanates such as 3,6-bis-(9-isocyanatononyl)-4,5-di-(1-heptenyl)-cyclohexene (dimeryl diisocyanate), α,α,α′,α′,α″,α″-hexamethyl-1,3,5-mesitylene triisocyanate, oligomers and polymers of the aforementioned isocyanates, and any desired mixtures of the aforementioned isocyanates. Preference is given to HDI and IPDI.

The polyurethane polymer has an average molecular weight of preferably 500 g/mol or above. In particular, the polyurethane polymer has an average molecular weight of 1,000 to 30,000 g/mol, preferably from 2,000 to 10,000 g/mol. Further, the polyurethane polymer preferably has an average NCO functionality in the range of 1.7 to 3, in particular 1.8 to 2.5.

The first component K1 preferably contains, in addition to the at least one polyurethane polymer containing isocyanate groups, other constituents.

Examples of possible such additional constituents are:
plasticizers, in particular esters of carboxylic acids, such as phthalates, more particularly dioctyl phthalate, diisononyl phthalate, or diisodecyl phthalate, adipates, in particular dioctyl adipate, azelates and sebacates, organic phosphoric and sulfonic acid esters or polybutenes;
non-reactive thermoplastic polymers, such as, for example, homopolymers or copolymers of unsaturated monomers, in particular from the group consisting of ethylene, propylene, butylene, isobutylene, isoprene, vinyl acetate and alkyl(methyl)acrylate, in particular, polyethylenes (PE), polypropylenes (PP), polyisobutylenes, ethylene vinyl acetate copolymers (EVA) and atactic poly-α-olefins (APAO);
solvents;
inorganic and organic fillers, in particular ground or precipitated calcium carbonates, optionally coated with fatty acids, in particular stearates, barite (BaSO₄, also called heavy spar), quartz powder, calcined kaolins, aluminum oxides, aluminum hydroxides, silicas, in particular highly disperse silicas from pyrolysis processes, carbon black, especially industrially manufactured carbon black (referred to hereinafter as: carbon black), PVC powder or hollow spheres;
fibers, made of polyethylene, for example;
pigments, for example titanium oxide or iron oxides;
blocked or latent isocyanate hardeners, in particular those selected from the group consisting of polyaldimines, oxazolidines, enamines and ketimines;
catalysts which accelerate the hydrolysis of the aldimine groups, especially acids, especially organic carboxylic acids such as benzoic acid, salicylic acid or 2-nitrobenzoic acid, organic carboxylic acid anhydrides, such as phthalic acid anhydride, hexahydrophthalic acid anhydride and hexahydromethyl phthalic acid anhydride, silyl esters of organic carboxylic acids, organic sulfonic acids such as methane sulfonic acid, p-toluene sulfonic acid or 4-dodecylbenzene sulfonic acid, sulfonic acid ester, other organic or inorganic acids, or mixtures of the aforementioned acids and acid esters;
catalysts which accelerate the reaction of the isocyanate groups, in particular organotin compounds such as dibutyltin diacetate, dibutyltin dialurate and dibutyltin dichloride, dibutyltin diacetylacetonate and dioctyltin dilaurate, bismuth compounds such as bismuthtrioctate and bismuthtris(neodecanoate), and compounds containing tertiary amino groups, such as 2,2′-dimorpholino diethyl ether and 1,4-diazabicyclo[2.2.2]octane;
rheology modifiers, in particular thickeners or thixotropic agents, for example, urea compounds, polyamide waxes, bentonites or pyrogenic silicas;
desiccants, such as molecular sieves, calcium oxides, highly reactive isocyanates, such as p-tosylisocyanate, monomeric diisocyanates, orthoformic acid esters, alkoxysilanes, such as tetraethoxysilane, organo alkoxysilanes, such as vinyl trimethyloxy silane and organo alkoxysilanes which contain a functional group in the α-position relative to the silane group;
adhesion promoters, in particular organo alkoxysilanes (“silanes”) such as, for example, expoxy silanes, vinyl silanes, (meth)acryl silanes, isocyanato silanes, carbamato silanes, alkyl silanes, s-(alklycarbonyl)-mercaptosilanes and aldiminosilanes, and oligomeric forms of these silanes;
stabilizers against heat, light radiation and UV radiation;
flame retardants;
surfactants, in particular wetting agents, flow control agents, deaerating agents or defoamers;
biocides, such as, for example, algaecides, fungicides or fungal growth inhibitor substances.

It is advantageous, when using the additional constituents of the composition, to ensure that these do not significantly impair the storage stability of the composition. This means that they should contain no water or, at most, traces of water. It may be useful to chemically or physically dry certain constituents before they are mixed in with the composition.

Preferably, the first component K1 contains at least one catalyst. The catalyst is a compound containing, in particular, a metal compound and/or a tertiary amino group. The quantity of catalyst is preferably 0.5 to 3.0% by weight, and more particularly 1 to 2% by weight, based on the weight of the first component K1.

Preferably, the first component K1 also contains at least one filler, in particular carbon black or chalk. The quantity of filler is preferably 10 to 50% by weight, and more particularly 20 to 40% by weight, based on the weight of the first component K1.

Preferably, the first component K1 further contains at least one polyaldimine. The polyaldimine is, in particular, one of the polyaldimines previously disclosed in US 2006/149025 A1, US 20091176944 A1, US 2009/099333 A1, WO 2008/116901 A1, WO 2009/010522 A1. Most preferably, the polyaldimine has the structural formula (III).

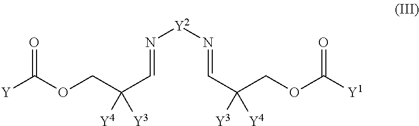

Herein, each Y¹, independently of one another, denotes an alkyl residue having 11 to 30 carbon atoms, preferably 11 to 16 carbon atoms; Y³ and Y⁴, independently of one another, denote an alkyl residue having 1 to 12 carbon atoms, preferably each denotes a methyl group; and Y² denotes a diamine DA having two primary amino groups after removal of these two amino groups.

Preferably, the diamine DA is selected from the group consisting of 1,6-hexamethylene diamine, 1,5-diamino-2-methylpentane (MPMD), 1,3-diaminopentane (DAMP), 2,2,4- and 2,4,4-trimethyl hexamethylene diamine, 4-aminomethyl-1,8-octanediamine, 1-amino-3-aminomethyl-3,5,5-trimethyl cyclohexane (=isophorone diamine or IPDA), 1,3- and 1,4-xylylene diamine, 1,3- and 1,4-bis-(aminomethyl)cyclohexane, bis-(4-aminocyclohexyl)-methane, bis-(4-amino-3-methylcyclohexyl)-methane, 3(4),8(9)-bis-(aminomethyl)-tricyclo-[5.2.1.0^{2,6}]decane, 1,2-, 1,3- and 1,4-diaminocyclohexane, polyoxyalkylene polyamine having two amino groups, in particular Jeffamine®EDR-148, Jeffamine® D-230 and Jeffamine® D-400; and, in particular, mixtures of two or more of these aforementioned diamines.

Most preferably, the first component K1 is a one-component moisture-curing polyurethane sealant or adhesive.

One-component, moisture-curing polyurethane sealants or adhesives of this type are commercially available, for example, under the series tradenames Sikaflex® and SikaTack® of the company Sika Schweiz AG. Especially preferred in this case is SikaTack®Move^{IT}, a one-component moisture-curing polyurethane adhesive sold commercially by Sika Schweiz AG.

One-component moisture-curing polyurethane sealants or adhesives of this type cure in the presence of moisture alone, that is, absent an accelerator component K2. In this case, however, the curing (without accelerator component K2) requires an extended period of time of several hours or days. The use of such a first component K1 has several advantages. For one, a customer can, if need be, utilize polyurethane adhesives already in use for less time-critical bonding. Secondly, metering errors or inhomogeneities when admixing the accelerator component K2 do not result in a failure of the bond, as often happens in the case of two-component adhesive and sealants. After several hours or days of post-curing the adhesive or sealant with moisture, the adhesive acquires approximately the same mechanical properties that would be acquired as when the accelerator component K2 is properly admixed.

The accelerator component K2 contains at least one salt of a tertiary amine and/or an organic quaternary ammonium salt.

In a first embodiment, the accelerator component K2 contains a salt of a tertiary amine. This involves, in particular, a compound that includes a tertiary amino group and a carboxylate group.

In this salt of a tertiary amine, the organic residues bound to the tertiary amine nitrogen are preferably aliphatic residues. Preferably, at least one of these organic residues contains aromatic structural elements. Such aromatic structural elements are, however, not directly bound to the tertiary amine-nitrogen.

The salt of the tertiary amine is preferably a compound of the formula (II).

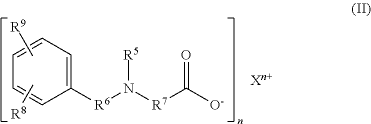

R⁵ denotes an alkyl group having 1 to 6 carbon atoms.

Furthermore, R⁶ and R⁷, each independently of one another, denote an alkylene group having 1 to 6 carbon atoms;

R⁸ denotes H or an alkyl group having 1 to 10 carbon atoms;

R⁹ denotes H or OH and X″ a cation having the charge n+.

Finally, n has a value of 1, 2 or 3.

It is particularly preferred for R⁵ to denote CH₃, for R⁶ to denote CH₂, R⁷ to denote CH₂, R⁸ to denote a n-alkyl group having 9 carbon atoms, R⁹OH, and for n to be 1 and for X to be Na.

This kind of preferred salt of a tertiary amine is commercially available under the name CURITHANE® 52 Catalyst from Air Products, or Huntsman.

In a second embodiment, the accelerator component K2 contains an organic quaternary ammonium salt. Preferably, this organic quaternary ammonium salt is a compound having at least one saturated ring, and more particularly a salt of a quaternary ammonium compound of the formula (Ia) or formula (Ib),

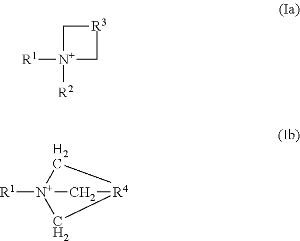

Here, R¹ and R² each, independently of one another, is a monovalent organic residue, in particular an alkyl group having 1 to 12 carbon atoms. Furthermore, R³ is a divalent organic residue having 2 to 20 carbon atoms, which optionally includes oxygen and or nitrogen atoms, in particular in the form of ether- or carboxy-oxygen atoms or amine- or ammonium-nitrogen atoms. Finally, R⁴ is a trivalent organic residue having 3 to 24 carbon atoms, which optionally includes oxygen and/or nitrogen atoms, in particular in the form of ether- or carboxy-oxygen atoms or amine- or ammonium-nitrogen atoms.

Quaternary ammonium salts of 1,4-diazabicyclo[2.2.2]octane (DABCO) of the formula (Ib-1) have been found to be particularly suitable.

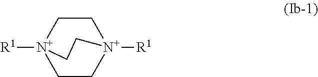

A preferred quaternary ammonium salt of this type can be commercially obtained under the tradename DABCO TMR-3® Catalyst from Air Product, or Huntsman.

The accelerator component K2 is preferably substantially free of water and/or of organic isocyanate-reactive compounds. Though not desirable, it is certainly possible for small amounts of water to be introduced by the substances used to build the accelerator component K2, small amounts of water in particular as a result of insufficient drying. Small amounts of water or organic isocyanate-reactive compounds, though not very disruptive, are nevertheless usually undesired. If the accelerator component K2 includes large amounts of water and/or organic isocyanate-reactive compounds, in particular polyols or polyamines, these react with the polyurethane polymers comprising the isocyanate groups during mixing of the components K1 and K2, which significantly alters the mechanics as compared to the slow curing of the component K1 alone in the presence of atmospheric moisture. If the accelerator component K2 includes substantial amounts of water, then, typically, large quantities of bubbles or large regions with damaged mechanics form, bringing with it, of course, significant disadvantages for the adhesive bond.

For this reason, it is preferable if the accelerator component K2 is completely free of water and/or organic isocyanate-reactive compounds.

It is especially preferred if the accelerator component K2 is substantially free, in particular completely free, of organic isocyanate-reactive compounds.

The accelerator component K2 can contain the following additional constituents.

Examples of possible such additional constituents are:
plasticizers, in particular esters of carboxylic acids, such as phthalates, more particularly dioctyl phthalate, diisononyl phthalate, or diisodecyl phthalate, adipates, in particular dioctyl adipate, azelates and sebacates, organic phosphoric and sulfonic acid ester or polybutenes;
non-reactive thermoplastic polymers, such as, for example, homopolymers or copolymers of unsaturated monomers, in particular from the group consisting of ethylene, propylene, butylene, isobutylene, isoprene, vinyl acetate and alkyl(methyl)acrylate, in particular polyethylenes (PE), polypropylenes (PP), polyisobutylenes, ethylene vinyl acetate copolymers (EVA) and atactic poly-α-olefins (APAO);
solvents;
inorganic and organic fillers, in particular ground or precipitated calcium carbonates, optionally coated with fatty acids, in particular stearates, barite (BaSO₄, also called heavy spar), quartz powder, calcined kaolins, aluminum oxides, aluminum hydroxides, silicas, in particular highly disperse silicas from pyrolysis processes, carbon blacks, especially industrially manufactured carbon blacks (referred to hereinafter as: carbon black), PVC powder or hollow spheres;
fibers, made of polyethylene, for example;
pigments, for example titanium oxide or iron oxides;
blocked or latent isocyanate hardeners, in particular those selected from the group consisting of polyaldimines, oxazolidines, enamines and ketimines;
rheology modifiers, in particular thickeners or thixotropic agents, for example, urea compounds, polyamide waxes, bentonites or pyrogenic silicas;
desiccants, such as molecular sieves, calcium oxide, highly reactive isocyanates, such as p-tosylisocyanate, monomeric diisocyanates, orthoformic acid esters, alkoxysilanes, such as tetraethoxysilane, organo alkoxysilanes, such as vinyl trimethyloxy silane and organo alkoxysilanes which contain a functional group in the α-position relative to the silane group;
adhesion promoters, in particular organo alkoxysilanes (“silanes”) such as, for example, expoxy silanes, vinyl silanes, (meth)acryl silanes, isocyanato silanes, carbamato silanes, alkyl silanes, s-(alklycarbonyl)-mercaptosilanes and aldiminosilanes, and oligomeric forms of these silanes;
stabilizers against heat, light radiation and UV radiation;
flame retardants;
surfactants, in particular wetting agents, flow control agents, deaerating agents or defoamers;
biocides, such as, for example, algaecides, fungicides or fungal growth inhibitor substances.

When using the additional constituents of the composition, it is advantageous to ensure that these do not significantly impair the storage stability of the composition. It may be useful to chemically or physically dry certain constituents before they are mixed in with the composition.

It is especially preferred for the accelerator component K2 to further contain at least one plasticizer and at least one filler.

Both the first component K1 and the accelerator component K2 preferably have a pasty consistency. Preferably, they have a comparable viscosity.

The salt of the tertiary amine or of the organic quaternary ammonium salt is present in the composition preferably in a quantity of 0.05 to 3% by weight, more particularly 0.5 to 2% by weight, and still more particularly 1 to 1.5% by weight, based on the weight of the first component K1.

The first component K1 and the accelerator component K2 are mixed together either before or during application.

The mixing ratio of the first component K1 and the accelerator component K2 is dependent, among other things, in particular on the amount of salt of the tertiary amine or of the organic quaternary ammonium salt in proportion to the amount of a polyurethane polymer containing isocyanate groups. It is preferable for the weight mixing ratio of the first component K1 and the accelerator component K2 to range between 39:1 and 9:1, preferably between 29:1 and 12:1.

A further aspect of the present invention relates to a method for mixing a two-component adhesive or sealant compound, as described in detail above. In particular, the accelerator component K2 is mixed in with the component K1 immediately prior to application or during application.

In one embodiment, the accelerator component K2 is admixed with the component K1 before the component K1 enters a static mixer.

In another embodiment, the component K1 is mixed with the accelerator component K2 in a dynamic mixer.

The result of the mixing of the first component K1 and the accelerator component K2 of a two-component adhesive or sealant compound, as described in detail above, is a mixed adhesive or sealant, which represents a further aspect of the present invention.

The adhesive or sealant composition described above is particularly suited for use as an adhesive or sealant, in particular in the manufacture or repair of vehicles or vehicle parts.

As previously described in detail above, the accelerator component K2 causes the curing of the first component K1 to accelerate.

Thus, a method for the accelerated curing of a one-component, moisture-curing polyurethane sealant or adhesive, to which an accelerator component K2 as described in detail above is admixed, represents a further aspect of the present invention.

A further aspect of the present invention relates to a method for applying an adhesive or sealant, comprising the following steps:

(i) mixing the two components K1 and K2 of a two-component adhesive or sealant composition, as described in detail above;

(ii) applying the components mixed according to step (i) to an adherend surface S1;

(iii) bringing the components mixed according to step (i) in contact with a second adherend surface S2;

(iv) curing the mixed components under the influence of water, more particularly in the form of atmospheric moisture.

In this case, the substrate S2 consists of the same material as the substrate S1, or of a different material.

The result of the above-described adhesive or sealant application method is bonded articles.

Surprisingly, it was found that the above-described compositions exhibit extremely interesting characteristics. They exhibit extremely rapid curing after mixing, but in the first phase after mixing, there is a time period in which the viscosity of the adhesive or sealant remains almost unchanged. During this period, the substrates to be bonded can be positioned or adjusted slightly, so that by adjusting, an optimal bonding geometry can be established. However, once this time period has passed, the viscosity and, thus, the bonding strength increase rapidly due to the cross-linking reactions that are taking place, and this allows the adhesive bond within a short period of time to be stressed by forces that customarily occur during transport or movement of the composite bodies on a conveyor belt. In addition, no fixing agents are needed in order to hold the composite together.

Adhesive and sealants with this kind of strength build-up behavior are optimally suited for industrial processes. For example, when installing automobile windshields, there passes a certain minimum time period that passes between the time the adhesive is first applied and the final positioning of the windshield on the vehicle body flange.

This strength behavior can be characterized by reference to viscosity. With the present invention, in particular adhesive or sealants can be achieved which have the following strength and viscosity behaviors:
when mixing the two components (t₀), the mixed adhesives have a viscosity of below less than 1500 Pa*s.
5 minutes after mixing the two components (t_{5 min}), the mixed adhesives have a viscosity of below less than 2200 Pa*s.
15 minutes after mixing the two components (t_{15 min}), the mixed adhesives have a viscosity of more than 2500 Pa*s, in particular of more than 5000 Pa*s.

Experience has shown that under these conditions, a measured viscosity of approximately 2400 Pa*s represents the limit at which the substrate can no longer be moved without destroying the adhesive bond, that is, at this value the adhesive bond has already acquired a strength at which small forces can be transferred via the adhesive bond.

It has also been found that above 2500 Pa*s, in particular above 5000 Pa*s, the strength has increased to the point that even larger stresses, such as those occurring during transport, can be transferred via the adhesive bond.

Further, it is preferable that 10 minutes after mixing of the two components (t_{10 min}), the mixed adhesives have a viscosity between 1500 and 5000 Pa*s.

The values set forth herein represent complex viscosities that are measured using a cone and plate Rheomat (Physics MCR 300) at a distance of 1 mm, oscillating at a constant amplitude (gamma=0.1) and constant frequency of 20 Hz at a temperature of 25° C. For these measurements, the two components (controlled to a temperature of 25° C.) were mixed in a dynamic mixer MBD 381-05-00 available from Sulzer, Switzerland, at 460 revolutions per minute (rpm).

It is clear to the skilled person that—as with any chemical reaction—the cross-linking reaction essential to the behavior of the strength build-up is dependent upon temperature. Thus, the same adhesive will cross-link more rapidly at a higher temperature, which results in a shorter open time and is primarily manifested in an increase in viscosity, measured after 5 minutes.

However, it is desirable for the same adhesive, measured at 25° C. using the above method, to exhibit a viscosity of less than 3200 Pa*s when similarly measured at 35° C. 5 minutes after the mixing of the two components (t_{5 min, 35° C.}).

It was further found that adhesives or sealants of this type exhibit mechanical final strengths that are substantially identical to those of the corresponding one-component adhesives or sealants, which consist exclusively of the first component K1, that is, without the addition of the accelerator component K2, and which are cured solely by long-term curing in atmospheric moisture. For this reason, adhesives or sealants of this type are also less sensitive to mixing errors, in sharp contrast to other two-component polyurethane adhesives (of the prior art), in which for curing it is important that the polyisocyanate component and the hardener component are mixed as completely as possible and using exactly the correct ratio. If, for example, in the case of the compositions according to the present invention the accelerator component is metered incorrectly or insufficiently intermixed, the adhesive still cures due to the curing of the first component in atmospheric moisture, even if the curing requires a longer period of time. The great economic advantage of this, however, is that articles produced with such deficient bondings do not have to be disposed of or recycled at great cost, but merely stored at atmospheric humidity, and in the end, after curing at atmospheric humidity, exhibit adhesive strengths that are substantially identical to those occurring when the accelerator components are correctly metered.

It was also found that the cured two-component adhesives or sealants are substantially free of bubbles or layers having insufficient mechanics, which is in sharp contrast to such prior art adhesives in which a water component is added, in particular by means of a static mixer, are.

### EXAMPLES

The following examples serve to illustrate the invention described above.

As seen in Table 1, different accelerators (except for Ref. 1) were formulated as accelerator components. These accelerator components were then admixed with SikaTack®Move^{IT} as the first component, more specifically by means of a dynamic mixer MBD 381-05-00, available from Sulzer, Switzerland, at a mixing ratio of 95 parts by weight of SikaTack®Move^{IT} to 5 parts by weight of accelerator. The comparative examples show the curing behavior of the one-component adhesive (Ref. 1), and of the adhesive with accelerators not according to the invention (Ref. 2 and Ref. 3).

After periods of 0 minutes (“Visc_{0/25° C.}”), 5 minutes (“Visc_{5/25° C.}”), 10 minutes (“Visc_{10/25° C.}”), and 15 minutes (“Visc_{15/25° C.}”) after mixing of the two components, the complex viscosity was measured (Rheomat (Physica MCR 300), plate/cone, distance=1 mm, oscillating at a constant amplitude (Gamma=0.1), constant frequency of 20 Hz, temperature=25° C.) was measured at 460 revolutions per minute.

The measured values are listed in Table 1.

An adhesive film 2 mm thick was produced from each of the mixed adhesive compositions as described above and the reference adhesive Ref. 1, each was cured for a period of 7 days at normal climate (23° C., 50% relative humidity). Then, dumbbells having a length of 75 mm, bar length of 30 mm and a bar width of 4 mm were punched out of the film. These dumbbells were then tested for their tensile strength and elongation at break in accordance with DIN EN 53504 at room temperature, at a pulling speed of 200 mm/min and listed in Table 1.

TABLE 1
Adhesive compositions in parts by weight and strength build-up via time-
dependent viscosities.

| | Ref. 1 | Ref. 2 | Ref. 3 | 1 | 2 |
|---|---|---|---|---|---|
| First component | 95 | 95 | 95 | 95 | 95 |
| [parts by weight] | | | | | |
| SikaTack ®-Move^{IT} | | | | | |
| Accelerator component | 0 | 5 | 5 | 5 | 5 |
| [parts by weight] | | | | | |
| Eisen(III)acetyl-acetonate | | 20 | | | |
| [% by weight] | | | | | |
| DABCO DC-1 ® | | | 20 | | |
| Catalyst [% by weight] | | | | | |
| DABCO TMR-3 ® | | | | 20 | |
| Catalyst [% by weight] | | | | | |
| CURITHANE ® 52 | | | | | 20 |
| [% by weight] | | | | | |
| Diisodecylphthalate | | 40 | 40 | 40 | 40 |
| (DIDP) [% by weight] | | | | | |
| Kaolin [% by weight] | | 40 | 40 | 40 | 40 |
| Visc_{0/25°C} [Pa · s] | 745 | 740 | 987 | 943 | 986 |
| Visc_{5/25°C} [Pa · s] | 643 | 639 | 1070 | 1350 | 2090 |
| Visc_{10/25°C} [Pa · s] | 640 | 635 | 1280 | 2000 | 3650 |
| Visc_{15/25°C} [Pa · s] | 650 | 651 | 1590 | 2780 | 5040 |
| Tensile strength [MPa] | 7.8 | 7.7 | 7.9 | 7.6 | 7.4 |
| Elongation at break [%] | 250 | 249 | 258 | 283 | 273 |

The comparison of Ref. 1 and Ref. 2 shows that the addition of iron(III)acetyl-acetonate to the adhesive in the observed time frame resulted in no noticeable acceleration. The addition of an amine accelerator (DABCO) to the adhesive (Ref. 3) resulted in insufficient acceleration, whereas the accelerators according to the invention (Examples 1 and 2), that is, the salt of a tertiary amine or an organic quaternary ammonium salt, were below the value critical for positioning during the relevant time period of up to 5 minutes, thereafter, however, within 15 minutes reached a high value which permits greater stresses.

Furthermore, from Example 2 at 35° C., the complex viscosity Vics_{5/35° C.}—analogous to Visc_{5/25° C.}—was measured 5 minutes after mixing of the two components of Example 2 that were controlled to a temperature 35° C. The correspondingly measured viscosity was 2950 Pa*s.

1. A two-component adhesive or sealant composition consisting of a first component K1 and an accelerator component K2;
wherein
the first component K1 contains at least one polyurethane polymer comprising isocyanate groups; and
the accelerator component K2 contains at least one salt of a tertiary amine and/or an organic quaternary ammonium salt.

2. The two-component adhesive or sealant composition according to claim 1, wherein the salt of a tertiary amine is a compound which has a tertiary amino group and a carboxylate group.

3. The two-component adhesive or sealant composition according to claim 1, wherein the organic quaternary ammonium salt is a compound having at least one saturated ring, in particular a salt of a quaternary ammonium compound of the formula (Ia) or formula (Ib), 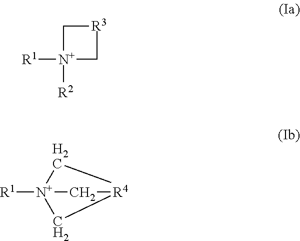
where R¹ and R² each, independently of one another, denote a monovalent organic residue, in particular an alkyl group, having 1 to 12 carbon atoms;
R³ denotes a divalent organic residue having 2 to 20 carbon atoms, which optionally contains oxygen and/or nitrogen atoms, in particular in the form of ether- or carboxy-oxygen atoms or amine- or ammonium nitrogen atoms;
R⁴ denotes a trivalent organic residue having 3 to 24 carbon atoms, which optionally contains oxygen and/or nitrogen atoms, in particular in the form of ether- or carboxy-oxygen atoms or amine- or ammonium-nitrogen atoms.

4. The two-component adhesive or sealant composition according to claim 1, wherein the salt of a tertiary amine is a compound of the formula (II) 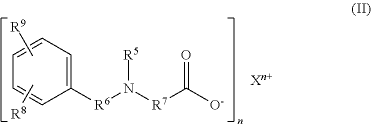
where R⁵ is an alkyl group having 1 to 6 carbon atoms;
R⁶ and R⁷ each, independently of one another, are an alkylene group having 1 to 6 carbon atoms;
R⁸ is H or an alkyl group having 1 to 10 carbon atoms;
R⁹ is H or OH and
Xⁿ⁺ is a cation having the charge n+ and
n has a value of 1, 2 or 3.

5. A two-component adhesive or sealant composition according to claim 1, wherein the salt of the tertiary amine or of the organic quaternary ammonium salt is present in the composition in an amount from 0.05 to 3% by weight based on the weight of the first component K1.

6. A two-component adhesive or sealant composition according to claim 1, wherein the accelerator component K2 also contains at least one plasticizer and at least one filler.

7. A two-component adhesive or sealant composition according to claim 1, wherein the first component K1 represents a one-component moisture-curing polyurethane sealant or adhesive.

8. A two-component adhesive or sealant composition according to claim 1, wherein the second component K2 contains less than 1% by weight of organic isocyanate-reactive compounds.

9. A mixed adhesive or sealant obtained by mixing the first component K1 and the accelerator component K2 of a two-component adhesive or sealant composition according to claim 1.

10. A method for mixing a two-component adhesive or sealant composition according to claim 1, wherein the accelerator component K2 is mixed with the component K1 immediately before the application or during the application.

11. The method according to claim 10, wherein the accelerator component K2 is admixed with the component K1 before the component K1 enters a static mixer.

12. The method according to claim 10, wherein the mixing of component K1 with the accelerator component K2 occurs in a dynamic mixer.

13. A method for applying adhesive or sealant, comprising the following steps:
(i) mixing the two components K1 and K2 of a two-component adhesive or sealant composition according to claim 1;
(ii) applying the components mixed according to step (i) to an adherend surface S1;
(iii) bringing the components mixed according to step (i) in contact with a second adherend surface S2;
(iv) curing the mixed components under the influence of water, in particular in the form of atmospheric moisture;
wherein the substrate S2 consists of the same material as the substrate S1, or of a different material.

14. A bonded article, having been bonded according to a method for applying of an adhesive or sealant according to claim 13.

15. A method of manufacturing or repairing vehicles or vehicle parts comprising: applying the adhesive or sealant composition according to claim 1 as an adhesive or sealant.

16. A method for the accelerated curing of a one-component, moisture-curing polyurethane sealant or adhesive, wherein an accelerator component K2, as described in the two-component adhesive or sealant composition according to claim 1, admixed with the sealant or adhesive.
